(19) United States
(12) Patent Application Publication
(10) Pub. No.: US 2012/0099706 A1
(43) Pub. Date: Apr. 26, 2012

(54) GRID FOR RADIOGRAPHY AND MANUFACTURING METHOD THEREOF, AND RADIATION IMAGING SYSTEM

(75) Inventor: Yasuhisa KANEKO, Ashigarakami-gun (JP)

(73) Assignee: FUJIFILM CORPORATION, Tokyo (JP)

(21) Appl. No.: 13/277,283

(22) Filed: Oct. 20, 2011

(30) Foreign Application Priority Data
Oct. 25, 2010 (JP) 2010-238618

(51) Int. Cl. G01N 23/201; C25D 5/02; G21K 1/00

(52) U.S. Cl. 378/87; 378/154; 205/122

(57) ABSTRACT

In an X-ray imaging system, first and second grids are disposed between an X-ray source and an X-ray image detector, and produce fringe images. From the fringe images, phase change information of X-rays is obtained. The phase change information provides contrast for an X-ray image. The first and second grids have similar configuration. Each grid is constituted of a grid layer and a support member. The grid layer includes X-ray absorbing portions and X-ray transparent portions arranged alternately in one direction. Each X-ray transparent portion contains hollow space having air trapped therein, for the purpose of reducing an X-ray absorption loss.

### BACKGROUND OF THE INVENTION

1. Field of the Invention

The present invention relates to a grid for radiography using radiation, and a manufacturing method of the grid, and a radiation imaging system.

2. Description Related to the Prior Art

When radiation e.g. X-rays is incident upon an object, the intensity and phase of the X-rays are changed by interaction between the X-rays and the object. At this time, the phase change of the X-rays is larger than the intensity change, in general. Taking advantage of these properties of the X-rays, X-ray phase imaging is developed and actively researched. In the X-ray phase imaging, a high-contrast image (hereinafter called phase contrast image) of a sample is obtained based on the phase change of the X-rays caused by the sample, even if the sample has low X-ray absorptivity.

As a type of the X-ray phase imaging, there is devised an X-ray imaging system using the Talbot effect, which is produced with two transmissive diffraction gratings (refer to U.S. Pat. No. 7,180,979 corresponding to Japanese Patent No. 4445397, and Applied Physics Letters Vol. 81, No. 17, page 3287 written by C. David et al. on October 2002, for example). In this X-ray imaging system, a first grid is disposed behind a sample when viewed from the side of an X-ray source, and a second grid is disposed downstream from the first grid by the Talbot distance. Behind the second grid, an X-ray image detector is disposed to detect the X-rays and produce the phase contrast image. Each of the first and second grids has narrow X-ray absorbing portions and X-ray transparent portions, which are arranged parallel to one another with aligning their edges. The Talbot distance refers to a distance at which the X-rays passed through the first grid forms a self image (fringe image) by the Talbot effect. The fringe image formed by the Talbot effect is modulated by the interaction (phase change) between the sample and the X-rays.

In the above X-ray imaging system, a moire pattern, which is produced by superimposition (intensity modulation) of the second grid on the self image of the first grid, is detected by a fringe scanning method in order to obtain phase information of the sample, that is, changes in phase of the X-rays due to the sample. In the fringe scanning method, an image is captured whenever the second grid is translationally moved relative to the first grid in a direction approximately parallel to a surface of the first grid and approximately orthogonal to a grid direction of the first grid by a scan pitch that is an integral submultiple of a grid pitch. From a change of each and every pixel value detected by the X-ray image detector, angular distribution (a differential phase image) of the X-rays refracted by the sample is obtained. Then, a phase contrast image of the sample is obtained based on the angular distribution. The fringe scanning method is available in an imaging system using laser light, instead of the X-rays (refer to Applied Optics Vol. 37, No. 26, page 6227 written by Hector Canabal et al. on September 1998, for example).

The first and second grids require high X-ray absorptivity at their X-ray absorbing portions. The X-ray absorbing portions of the second grid, in particular, require higher X-ray absorptivity than those of the first grid, to reliably apply the intensity modulation to the fringe image. Thus, the X-ray absorbing portions of the first and second grids are made of gold (Au) with high atomic weight. Also, the X-ray absorbing portions of the second grid need to have relatively large thickness (high aspect ratio) in a propagation direction of the X-rays. As a result, the second grid has such a fine configuration that the X-ray absorbing portions have a pitch of several micrometers and a thickness of several tens to a hundred and several tens micrometers.

The X-ray transparent portions of the first and second grids, on the other hand, require a low X-ray absorption loss. The X-ray transparent portions are conventionally formed of an insulating substance such as silicon oxide, resin, or LPD ceramic (refer to the U.S. Pat. No. 7,180,979). In another case, the X-ray absorbing portions are arranged at constant distance with leaving gaps therebetween, so that the gaps function as the X-ray transparent portions (refer to Japanese Patent Laid-Open Publication No. 2009-0142528).

However, in the case of making the X-ray transparent portions out of the silicon oxide or the LPD ceramic, as described in the U.S. Pat. No. 7,180,979, the X-ray absorption loss arises because these substances have the X-ray absorptivity. The X-ray absorptivity of the resin is lower than those of the silicon oxide and the LPD ceramic, but still not zero. Therefore, the X-ray absorption loss still arises with use of the resin.

In the case of leaving the gaps between the adjoining X-ray absorbing portions, as described in the Japanese Patent Laid-Open Publication No. 2009-042528, since the X-ray absorbing portions have a high aspect ratio, more specifically have a width of several micrometers and a thickness of the order of 100 micrometers, the X-ray absorbing portions fall and incline in its width direction. This results in degradation in grid performance, and thus this method is unrealistic.

### SUMMARY OF THE INVENTION

An object of the present invention is to provide a grid having radiation transparent portions with a low radiation absorption loss, a manufacturing method of the grid, and a radiation imaging system using the grid.

To achieve the above and other objects, a grid for radiography according to the present invention includes a plurality of radiation absorbing portions made of a radiation absorbing material, and a plurality of radiation transparent portions made of a radiation transparent material containing hollow space. The radiation absorbing portions and the radiation transparent portions are alternately arranged.

The hollow space is preferably formed of air bubbles dispersed in the radiation transparent material, or hollow beads dispersed in the radiation transparent material. The radiation transparent material is preferably a resin paste.

The grid may further include a reinforcing layer formed between the radiation absorbing portion and the radiation transparent portion, or a support member formed integrally with the radiation transparent portions.

In the grid, each of the radiation absorbing portions and the radiation transparent portions preferably extends in a first direction. The radiation absorbing portions and the radiation transparent portions are preferably arranged alternately in a second direction orthogonal to the first direction.

A manufacturing method of the grid includes the steps of forming a seed layer on a surface of abase substrate; first etching the base substrate on a side of the seed layer through a first etching mask, to form first grooves; depositing a radiation transparent material in each first groove so as to make hollow space inside the first groove, to form radiation transparent portions; second etching the base substrate on a side opposite from that of the first etching step, using the radiation transparent portions as a second etching mask, to remove the base substrate from between the radiation transparent portions and form second grooves having the seed layer at each bottom; and charging a radiation absorbing material into the second grooves by electrolytic plating using the seed layer as an electrode, to form radiation absorbing portions.

In a radiation imaging system according to the present invention, the grid described above is used as at least one of the first and second grids.

According to the grid for radiography of the present invention, the radiation transparent portion contains the hollow space with low X-ray absorptivity, and hence has the low radiation absorption loss. Since the radiation imaging system according to the present invention uses the grid having the low radiation absorption loss at its radiation transparent portions, the contrast of a fringe image is improved. As a result, it is possible to obtain a phase contrast image with high image quality.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view of an X-ray imaging system according to a first embodiment;

FIG. 2 is a plan view of a second grid;

FIG. 3 is a cross sectional view of the second grid;

FIG. 4 is an explanatory view of a first step in a manufacturing process of the second grid;

FIG. 5 is an explanatory view of a second step in the manufacturing process of the second grid;

FIG. 6 is an explanatory view of a third step in the manufacturing process of the second grid;

FIG. 7 is an explanatory view of a fourth step in the manufacturing process of the second grid;

FIG. 8 is an explanatory view of a fifth step in the manufacturing process of the second grid;

FIG. 9 is an explanatory view of a sixth step in the manufacturing process of the second grid;

FIG. 10 is an explanatory view of a seventh step in the manufacturing process of the second grid;

FIG. 11 is an explanatory view of an eighth step in the manufacturing process of the second grid;

FIG. 12 is an explanatory view of a ninth step in the manufacturing process of the second grid;

FIG. 13 is a cross sectional view of a second grid according to a second embodiment; and

FIG. 14 is a cross sectional view of a second grid according to a third embodiment.

### DESCRIPTION OF THE PREFERRED EMBODIMENTS

### First Embodiment

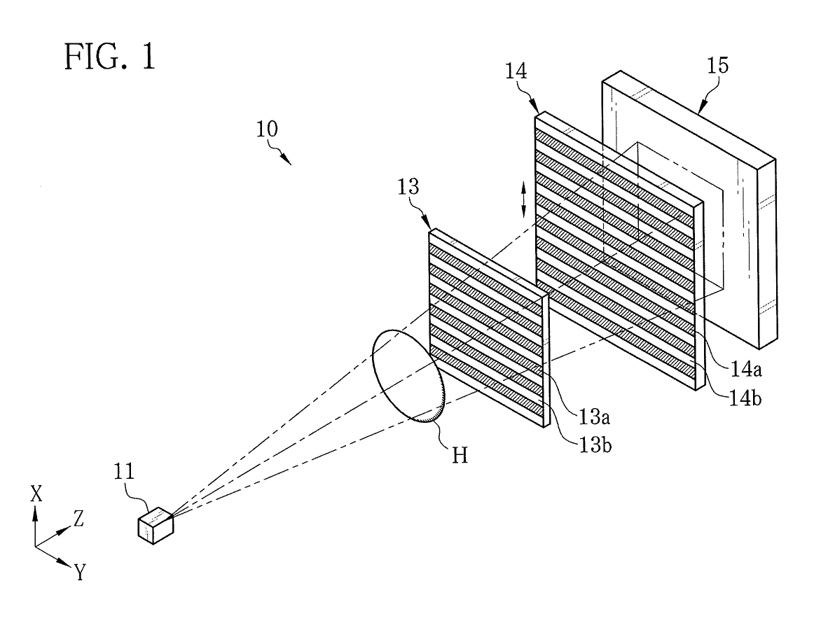

As shown in FIG. 1, an X-ray imaging system 10 is constituted of an X-ray source 11, a first grid 13, a second grid 14, and an X-ray image detector 15. The X-ray source 11 has a rotation-anode type X-ray tube and a collimator for limiting an irradiation field of X-rays, for example, and applies the X-rays to a sample H. The first and second grids 13 and 14, being of an X-ray absorptive type, are opposed to the X-ray source 11 in a Z direction corresponding to an X-ray propagation direction. The first grid 13 is disposed at a certain distance away from the X-ray source 11 so as to place the sample H therebetweeen. The X-ray image detector 15 is a flat panel detector (FPD) composed of semiconductor circuitry, for example, and is disposed behind the second grid 14.

The first grid 13 is provided with plural X-ray absorbing portions 13a and X-ray transparent portions 13b, which extend in a Y direction being one direction in a plane orthogonal to the Z direction. The X-ray absorbing portions 13a and the X-ray transparent portions 13b are alternately arranged in an X direction orthogonal to both the Z and Y directions, so as to form a grid with a stripe pattern. As with the first grid 13, the second grid 14 is provided with plural X-ray absorbing portions 14a and X-ray transparent portions 14b, which extend in the Y direction and are alternately arranged in the X direction.

Now, the configuration of the second grid 14 will be described. Note that, the first grid 13 has a configuration similar to that of the second grid 14, except for the width and pitch of the X-ray absorbing portions 13a in the X direction, the thickness of the X-ray absorbing portions 13a in the Z direction, and the like. Thus, the detailed description of the first grid 13 is omitted.

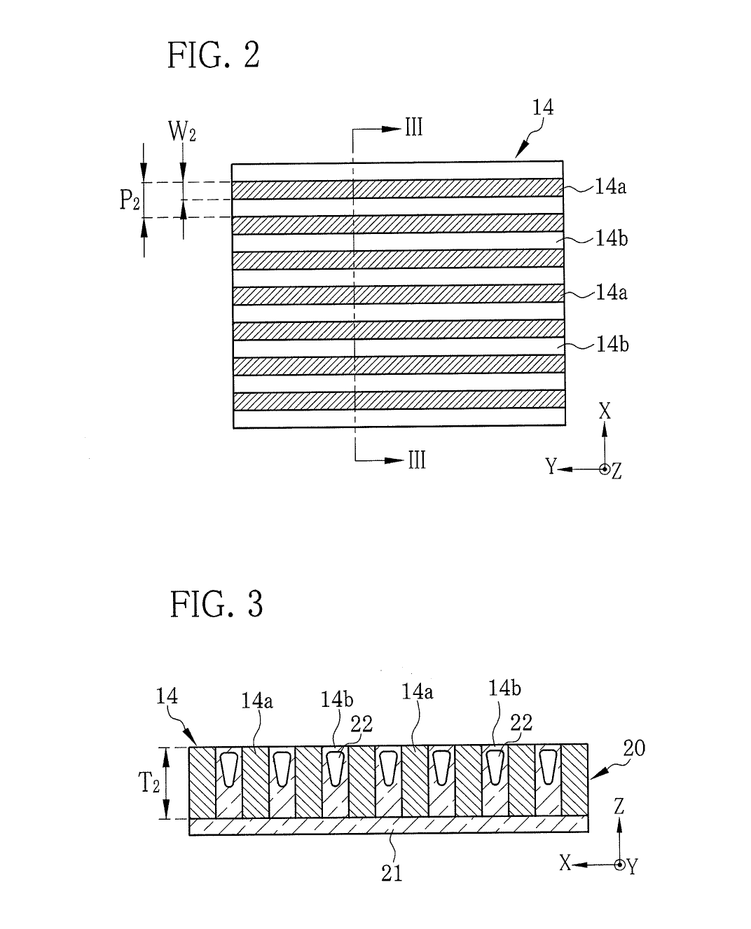

FIG. 2 is a plan view of the second grid 14 viewed from the side of the X-ray source 11. FIG. 3 shows a cross sectional view taken along line III-III of FIG. 2. The second grid 14 has a grid layer 20 including the X-ray absorbing portions 14a and the X-ray transparent portions 14b, and a support member 21 for supporting the grid layer 20. The X-ray absorbing portions 14a are made of metal with high X-ray absorptivity, such as gold (Au) or platinum (Pt).

The X-ray transparent portions 14b and the support member 21 are made of X-ray transparent material such as silicon nitride (SiN). Each X-ray transparent portion 14b contains hollow space 22 in which air having low X-ray absorptivity is trapped. The hollow space 22 preferably occupies one-tenth or more volume within an area corresponding to a single pixel (approximately 150 μm square) of the X-ray image detector 15. Note that, the hollow space 22 may contain gas other than air, such as nitrogen, oxygen, or hydrogen. The inside of the hollow space 22 may be vacuumed to further reduce the X-ray absorption loss.

The width W₂ and arrangement pitch P₂ of the X-ray absorbing portion 14a in the X direction depend on the distance between the X-ray source 11 and the first grid 13, the distance between the first grid 13 and the second grid 14, the arrangement pitch of the X-ray absorbing portions 13a of the first grid 13, and the like. By way of example, the width W₂ is approximately 2 to 20 μm, and the arrangement pitch P₂ is in the order of 4 to 40 μm being twice the width W₂. The thickness T₂ of the X-ray absorbing portion 14a in the Z direction is in the order of 100 μm, in consideration of vignetting of a cone beam of X-rays emitted from the X-ray source 11. In this embodiment, the second grid 14 has a width W₂ of 2.5 μm, an arrangement pitch P₂ of 5 μm, and a thickness T₂ of 100 μm, for example.

Next, the operation of the X-ray imaging system 10 will be described. When the X-rays emitted from the X-ray source 11 pass through the sample H, phase difference arises in the X-rays. Subsequently, a fringe image is formed by transmitting the X-rays through the first grid 13. The fringe image includes transmission phase information of the sample H, which is determined by the refractive index of the sample H and the length of a transmission optical path.

The intensity of the fringe image is modified by transmitting through the second grid 14. Then, the fringe image after the intensity modulation is detected by, for example, a fringe scanning method. To be more specific, the second grid 14 is translationally moved relative to the first grid 13 at a scan pitch that is an equal division (for example, one-fifth) of a grid pitch in the X direction, which is along a grid surface with respect to an X-ray focus. During this translational movement of the second grid 14, the X-ray source 11 applies the X-rays to the sample H, and the X-ray image detector 15 captures plural fringe images. Then, a differential phase image (corresponding to angular distribution of the X-rays refracted by the sample H) is obtained from a phase shift amount (a shift amount in phase between in the presence of the sample H and in the absence of the sample H) of pixel data of each pixel detected by the X-ray image detector 15. Integrating the differential phase image along a fringe scanning direction allows obtainment of a phase contrast image of the sample H.

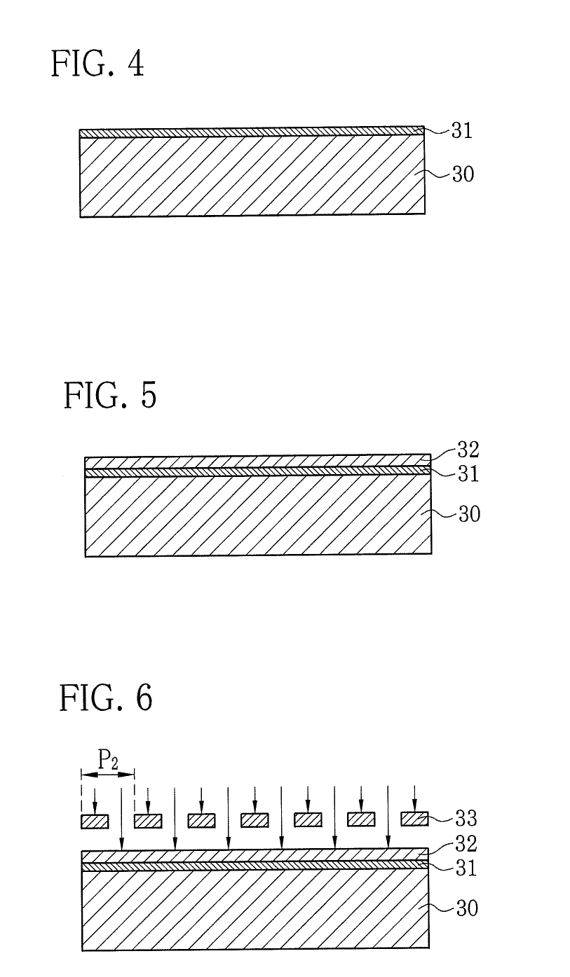

Next, a manufacturing method of the second grid 14 will be described. Note that, since the first grid 13 is manufactured in the same way, detailed explanation about a manufacturing method of the first grid 13 is omitted. FIGS. 4 to 12, which show a manufacturing process of the second grid 14, are cross sectional views along an XZ plane defined by the X and Z directions. In a first step, as shown in FIG. 4, a seed layer 31 made of Au is formed on a surface of a silicon (Si) base substrate 30 by sputtering or chemical vapor deposition (CVD).

In a second step, an etching mask is formed on the top of the base substrate 30 using a generally known photolithography technique. As shown in FIG. 5, a resist layer 32 is formed on a surface of the seed layer 31. To form the resist layer 32, for example, the step of applying a liquid resist to the surface of the seed layer 31 by spin coating or the like, and the step of vaporizing an organic solvent from the applied liquid resist by baking or the like are carried out.

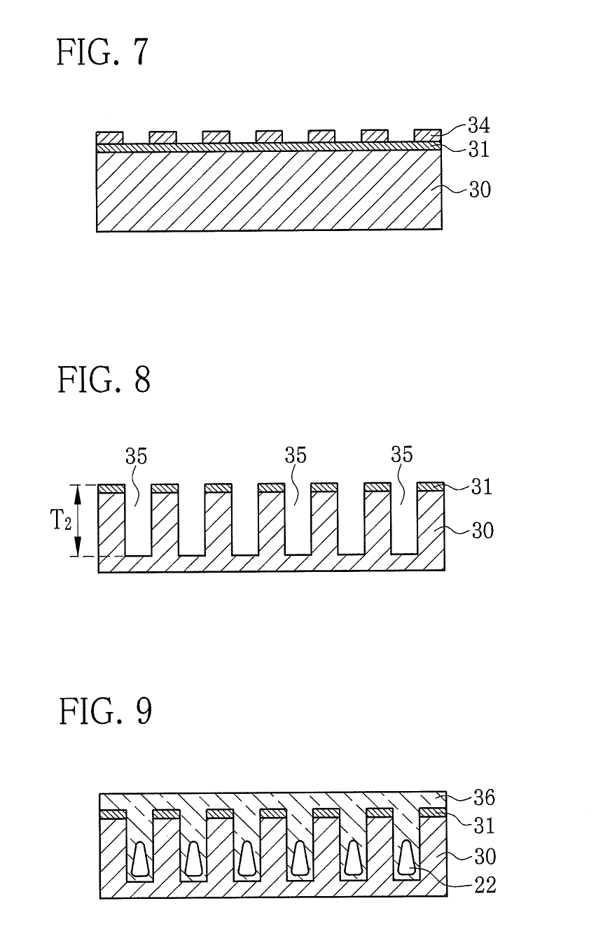

In a third step, as shown in FIG. 6, light e.g. ultraviolet rays is applied to the resist layer 32 through a photomask 33, which has a stripe pattern with lines at the pitch P₂. Then, in a fourth step, as shown in FIG. 7, exposed portions of the resist layer 32 is removed by a developing solution. Remaining portions (unexposed portions) of the resist layer 32 compose an etching mask 34 with the stripe pattern that has lines extending in the Y direction and arranged in the X direction. Each line of the etching mask 34 has a width of 2.5 μm, and the clearance between the lines has a width of 2.5 μm, for example. Note that, the resist layer 32 is formed of a positive resist, but may be made of a negative resist. Instead of the etching mask composed of the resist layer, a metal etching mask or the like is usable.

Next, in a fifth step, as shown in FIG. 8, a plurality of grooves (first grooves) 35, which extend in the Y direction and are arranged in the X direction, are formed in the seed layer 31 and the base substrate 30 by dry etching using the etching mask 34. After that, the etching mask 34 is removed by asking. To form the deep grooves 35 with a high aspect ratio, deep dry etching is carried out. As the deep dry etching, a method called Bosch process is used by which the etching and the deposition of a protective film are performed alternately and repeatedly.

In the Bosch process, the etching is performed using a SF₆ gas for etching silicon and a C₄F₈ gas for forming the protective film. Since the SF₆ gas promotes the etching not only in a depth direction but also in a lateral direction, a deep hole or groove cannot be formed only with use of the SF₆ gas. Thus, in the Bosch process, the SF₆ gas is switched into the C₄F₈ gas after the etching is carried out for predetermined time, to deposit a CFn polymer produced by plasma. The CFn polymer forms the protective film on the etched grooves. After that, the etching is performed again using the SF₆ gas. Since side faces of the groove are etched at lower etching speed than a bottom face of the groove, only the bottom face is etched. Repeating the above steps allows formation of the deep grooves with the high aspect ratio.

The Bosch process is carried out on etching conditions that, for example, gas pressure is 1 to 10 Pa, a switching interval between the SF₆ gas and the C₄F₈ gas is in the order of 5 to 10 seconds, and power is 600 W. Under these conditions, the etching speed is 2 μm/min, and the depth T₂ of the groove 35 is 100 μm, for example. In this etching, the formation of the high density plasma is of primary importance. There are various methods for forming the high density plasma, including a method using inductively coupled plasma (ICP), a method using helicon waves, and the like. Note that, the grooves may be formed by wet etching considering plane orientation of a silicon single crystal, instead of the dry etching.

Next, in a sixth step, as shown in FIG. 9, an insulating X-ray transparent material 36 made of silicon nitride (SiN) is deposited in the grooves 35 by the CVD. At this time, the X-ray transparent material 36 is charged into each groove 35 with leaving hollow space 22 therein, due to the high aspect ratio of the groove 35. The hollow space 22 easily occurs, when a charging speed of the X-ray transparent material 36 by the CVD is increased. Thus, controlling the charging speed of the X-ray transparent material 36 allows adjustment of the size of the hollow space 22.

The X-ray transparent material 36 deposited in the grooves 35 composes the X-ray transparent portions 14b. The X-ray transparent material 36 is deposited on the entire seed layer 31 so as to compose the support member 21, in addition to being charged into the grooves 35. The hollow space 22 is not necessarily continuous in the Y direction, but may be divided at random intervals depending on manufacturing conditions and the like.

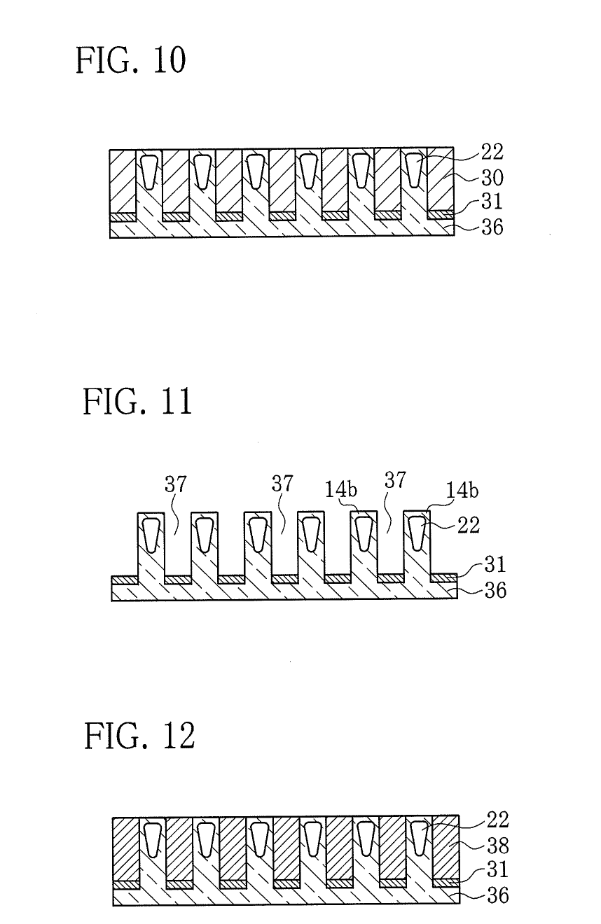

In a next seventh step, as shown in FIG. 10, a structure of FIG. 9 is turned upside down. The surface of the base substrate 30 is polished flat by chemical mechanical polishing (CMP), until the X-ray transparent material deposited in the bottom of the grooves 35 is exposed outside. Then, as shown in FIG. 11, in an eighth step, the base substrate 30 is etched and removed using the X-ray transparent material 36 as the etching mask. Thus, grooves (second grooves) 37 are formed between the X-ray transparent portions 14b, and the seed layer 31 is exposed from the bottom of each groove 37. In etching the base substrate 30 using the X-ray transparent material 36 as the etching mask, as described above, an etching rate of the X-ray transparent material 36 has to be lower than that of the base substrate 30. The composition of the X-ray transparent material 36 and the base substrate 30 may be determined based on a selection ratio (ratio between the etching rates) in the dry etching carried out in this step.

In a next ninth step, as shown in FIG. 12, an X-ray absorbing material 38 made of gold (Au) is embedded in the grooves 37 by electrolytic plating using the seed layer 31 as an electrode. The seed layer 31 and the X-ray absorbing material 38 compose the X-ray absorbing portions 14a. In the electrolytic plating, a current terminal is connected to the seed layer 31. The seed layer 31 disposed in the bottom of every groove 37 is preferably linked outside the grooves 37 so as to be connectable to the current terminal at a single position, though it is not shown in the drawing.

In the electrolytic plating, a structure of FIG. 11 having the X-ray absorbing material 36 and the seed layer 31 is immersed in a plating solution, and an anode is opposed to the seed layer 31 therein. Then, by flowing electric current between the seed layer 31 and the anode, metal ions contained in the plating solution are deposited on the seed layer 31. Thereby, the grooves 37 are filled with Au. In the electrolytic plating of Au, for example, cyanide gold plating, KAu(CN)₂ is used as a plating solution, and KH₂PO₄ or KOH is added as a pH buffer material, such that the plating solution has a pH of 6 to 8. The plating solution has a temperature of 25 to 70° C. The density of the electric current is 0.2 to 1 A/cm², and Pt-plated Ti is used as the anode. Note that, the above conditions of the Au plating are just one example, and the Au plating can be carried out with another plating solution and on other conditions.

Through the manufacturing process described above, the second grid 14 having the grid layer 20 and the support member 21 is completed. In the above embodiment, SiN is used as the X-ray transparent material 36, but an organic material such as polyimide or poly-para-xylylene, or an inorganic material such as SiO₂ or SiC is available. To vacuum the inside of the hollow space 22, the X-ray transparent material 36 may be deposited in a vacuum environment by the CVD.

Now, other embodiments of the present invention will be described. In the following embodiments, the same reference numerals as those of the first embodiment indicate the same components, and detailed description of them is omitted. In the following embodiments, a first grid has configuration similar to a second grid except for a grid pitch, a thickness, and the like, and is manufactured by a similar process. Thus, detailed description of the first grid is omitted.

### Second Embodiment

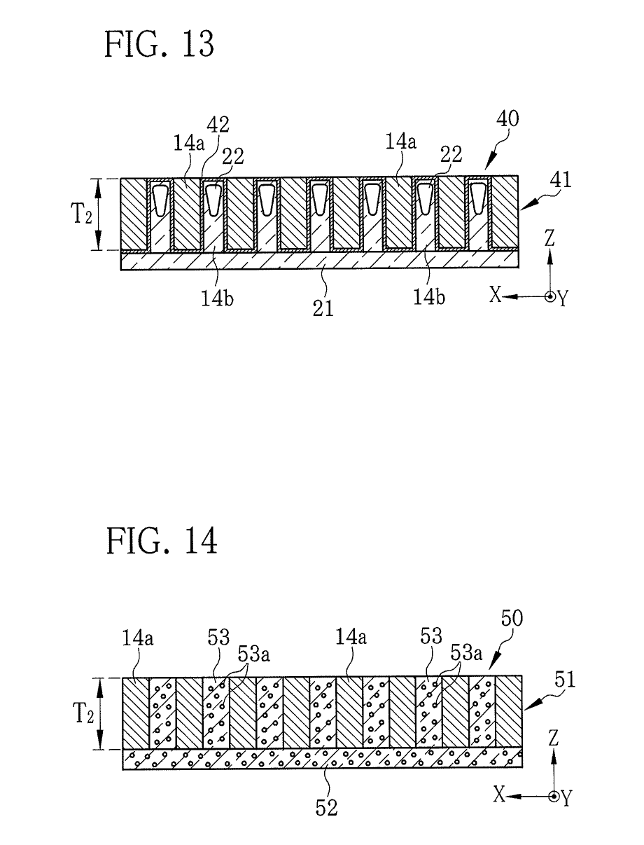

FIG. 13 shows a cross section of a second grid 40 according to this embodiment taken along the XZ plane. The second grid 40 includes a grid layer 41 and the support member 21. The grid layer 41 has the X-ray absorbing portions 14a and the X-ray transparent portions 14b arranged alternately in the X direction, and a reinforcing layer 42 formed between the X-ray absorbing portion 14a and the X-ray transparent portion 14b. The reinforcing layer 42 is formed between the X-ray absorbing portion 14a and the support member 21.

The reinforcing layer 42 is preferably formed of a material with high X-ray transparency and high stiffness, for example, SiO₂. In a case where the X-ray transparent portions 14b are made of the organic material such as resin, there is a possibility of deformation of the X-ray transparent portions 14b. The reinforcing layer 42 has the high stiffness enough to maintain the shape of the X-ray transparent portions 14b and prevent the deformation thereof. Also, the reinforcing layer 42 prevents the corrosion of the X-ray absorbing portions 14a due to the organic material composing the X-ray transparent portions 14b.

In a manufacturing process of the second grid 40, the step of forming the reinforcing layer 42 may be added between the fifth step shown in FIG. 8 and the sixth step shown in FIG. 9 in the manufacturing method of the second grid 14 according to the first embodiment. The reinforcing layer 42 is formed so as to cover the bottom and side faces of the grooves 35 and the surface of the seed layer 31 by the CVD. The other steps of the manufacturing process are the same as those of the first embodiment, and the detailed description thereof is omitted.

### Third Embodiment

FIG. 14 shows a cross section of a second grid 50 according to this embodiment taken along the XZ plane. The second grid 50 has a grid layer 51 and a support member 52. The grid layer 51 is constituted of the X-ray absorbing portions 14a and X-ray transparent portions 53 arranged alternately in the X direction. The X-ray transparent portions 53 and the support member 52 are made of a resin paste with high X-ray transparency. As the resin paste, for example, an acrylic resin having air bubbles 53a dispersed therein is used.

To manufacture the second grid 50, in the sixth step shown in FIG. 9 of the manufacturing process of the second grid 14 according to the first embodiment, the resin paste containing the air bubbles 53a may be charged into the grooves 35 and dried therein, instead of depositing the X-ray transparent material 36 in the grooves 35 by the CVD. The resin paste is produced by dispersing a resin material in a solvent. Then, to form the air bubbles 53a, the resin paste is agitated so as to mix air therein. The other steps of the manufacturing process are the same as those of the first embodiment, the detailed description thereof is omitted.

As with the second embodiment, the reinforcing layer may be formed between the X-ray absorbing portion 14a and the X-ray transparent portion 53. Instead of the resin paste having the dispersed air bubbles 53a, a resin paste having hollow resin beads dispersed therein may be used. In this case, there is no need to agitate the resin paste, and the manufacturing process becomes easier.

### Other Embodiments

In the above first and second embodiments, the hollow space is formed in each X-ray transparent portion, and the distribution of the hollow space is preferably uniform in an XY plane. However, the hollow space may be distributed higher at a marginal portion than at a middle portion. In this case, the X-ray transparency of the X-ray absorbing portion is increased with approaching from the center of the grid to its ends. The X-rays emitted from the X-ray source 11 is the cone beam, and the intensity of the X-rays is decreased with approaching from the center of the grid to its ends. Therefore, since the distribution of the X-ray transparency compensates for the intensity distribution of the X-rays, the intensity distribution of the X-rays passed through the X-ray transparent portions of the grid becomes substantially uniform.

If there is too much hollow space in the marginal portion of the grid, the physical strength of the grid is reduced. For this reason, the hollow space may be distributed higher at the middle portion than at the marginal portion, contrarily to above.

In each of the above embodiments, the present invention is explained with taking the first and second grids as an example, but the present invention is applicable to a source grid, if the source grid is provided on an X-ray emission side of the X-ray source 11.

The first and second grids linearly project the X-rays passed through their X-ray transparent portions. However, the first and second grids may diffract the X-rays at their X-ray transparent portions to produce the so-called Talbot effect (similar to U.S. Pat. No. 7,180,979). In this case, however, the distance between the first and second grids has to be set at the Talbot distance. In this case, a phase grating instead of an absorption grating may be used as the first grid, and the phase grating used as the first grid projects a fringe image (self image) produced by the Talbot effect to the second grid.

In the above embodiments, the sample H is disposed between the X-ray source and the first grid, but may be disposed between the first grid and the second grid. The phase contrast image can be produced in this case, just as with above.

The embodiments described above are applicable to various types of radiation imaging systems for medical use, industrial use, nondestructive inspection use, and the like. The present invention is applicable to an anti-scatter grid for removing scattered rays in X-ray imaging. Furthermore, in the present invention, y-rays or the like is usable as radiation instead of the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A grid for radiography comprising:
a plurality of radiation absorbing portions made of a radiation absorbing material; and
a plurality of radiation transparent portions made of a radiation transparent material containing hollow space, said radiation absorbing portions and said radiation transparent portions being alternately arranged.

2. The grid according to claim 1, wherein said hollow space is formed of air bubbles dispersed in said radiation transparent material.

3. The grid according to claim 1, wherein said hollow space is formed of hollow beads dispersed in said radiation transparent material.

4. The grid according to claim 1, wherein said radiation transparent material is a resin paste.

5. The grid according to claim 1, further comprising:
a reinforcing layer formed between said radiation absorbing portion and said radiation transparent portion.

6. The grid according to claim 1, further comprising:
a support member formed integrally with said radiation transparent portions.

7. The grid according to claim 1,
wherein each of said radiation absorbing portions extends in a first direction;
wherein each of said radiation transparent portions extends in said first direction; and
said radiation absorbing portions and said radiation transparent portions are alternately arranged in a second direction orthogonal to said first direction.

8. A manufacturing method of a grid for radiography comprising the steps of:
forming a seed layer on a surface of a base substrate;
first etching said base substrate on a side of said seed layer through a first etching mask, to form first grooves;
depositing a radiation transparent material in each of said first grooves so as to make hollow space inside said first groove, to form radiation transparent portions;
second etching said base substrate on a side opposite from that of the first etching step, using said radiation transparent portions as a second etching mask, to remove said base substrate from between said radiation transparent portions and form second grooves having said seed layer at each bottom; and
charging a radiation absorbing material into said second grooves by electrolytic plating using said seed layer as an electrode, to form radiation absorbing portions.

9. A radiation imaging system having a first grid for transmitting radiation emitted from a radiation source to produce a fringe image, a second grid for applying intensity modulation to said fringe image at plural relative positions having phases different from that of a periodic pattern of said fringe image, and a radiation image detector for detecting said fringe image after being subjected to said intensity modulation by said second grid at each of said relative positions, said radiation imaging system, wherein the grid for radiography according to claim 1 is used as at least one of said first and second grids.
